(19) United States
(12) Patent Application Publication
(10) Pub. No.: US 2024/0419188 A1
(43) Pub. Date: Dec. 19, 2024

(54) OPERATION CONTROL SYSTEM OF MOBILE OBJECT, MANAGEMENT DEVICE, CONTROL METHOD THEREOF, AND STORAGE MEDIUM

(71) Applicant: HONDA MOTOR CO., LTD., Tokyo (JP)

(72) Inventor: Andrii PYDIN, Wako-shi (JP)

(21) Appl. No.: 18/816,081

(22) Filed: Aug. 27, 2024

Related U.S. Application Data
(63) Continuation of application No. PCT/JP2022/009219, filed on Mar. 3, 2022.

(51) Int. Cl. G05D 1/622; G05D 1/246; G05D 1/248; G05D 1/646; G05D 1/693; G05D 105/20; G05D 107/70; G05D 111/10; G05D 111/30

(52) U.S. Cl. CPC G05D 1/622; G05D 1/246; G05D 1/248; G05D 1/646; G05D 1/693; G05D 2105/20; G05D 2107/70; G05D 2111/10; G05D 2111/32

(57) ABSTRACT

An operation control system of a mobile object configured to be autonomously movable, the operation control system comprising: a position detection unit configured to detect a position of the mobile object; a recognition unit configured to recognize a state of a periphery of the mobile object; a decision unit configured to decide, in a case where the mobile object is in a stopped state, a condition for another mobile object to pass by the mobile object according to a result of the recognition by the recognition unit; and a sharing unit configured to share information indicating the position of the mobile object in the stopped state detected by the position detection unit and the condition decided by the decision unit with the other mobile object.

### CROSS-REFERENCE TO RELATED APPLICATION(S)

This application is a continuation of International Patent Application No. PCT/JP2022/009219 filed on Mar. 3, 2022, the entire disclosures of which is incorporated herein by reference.

### BACKGROUND OF THE INVENTION

### Field of the Invention

The present invention relates to an operation control system of a mobile object, a management device, a control method thereof, and a storage medium.

### Description of the Related Art

In a case where a large-scale facility, such as solar panels, is constructed in a relatively large site space, it is effective to use autonomously traveling type dollies as a means for transporting various materials to designated locations in terms of cost. The dollies each include a camera and a GPS or the like for detecting its own position information, and travel to a destination point according to a route on a map with reference to map data prepared in advance.

Incidentally, in a case where a dolly is stopped on the route, the dolly can become an obstacle and prevent other dollies from traveling.

Japanese Patent Laid-Open No. 2020-21452 discloses that in a case where a mobile object is stopped, a width of a space in the vicinity of the mobile object is measured and compared with a width of another mobile object approaching the mobile object, and if it is determined that the other mobile object cannot pass by, the mobile object moves.

According to Japanese Patent Laid-Open No. 2020-21452, it is determined whether another mobile object can pass by the stopped mobile object only after the other mobile object reaches the vicinity of the stopped mobile object. Therefore, in a case where the stopped mobile object cannot move due to an accident, such as an engine trouble, and the space in the vicinity of the stopped mobile object is not sufficient, the other mobile object will turn back.

### SUMMARY OF THE INVENTION

The present invention has been made in view of such a problem, and provides a technique for deciding a condition related to the size of a mobile object that can pass by a certain mobile object when the certain mobile object is in a stopped state, and sharing the condition with other dollies.

According to one aspect of the present invention, there is provided an operation control system of a mobile object configured to be autonomously movable, the operation control system comprising:
a position detection unit configured to detect a position of the mobile object;
a recognition unit configured to recognize a state of a periphery of the mobile object;
a decision unit configured to decide, in a case where the mobile object is in a stopped state, a condition for another mobile object to pass by the mobile object according to a result of the recognition by the recognition unit; and
a sharing unit configured to share information indicating the position of the mobile object in the stopped state detected by the position detection unit and the condition decided by the decision unit with the other mobile object.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is an overall configuration diagram of a dolly operation system according to an embodiment;

FIG. 2 is a block configuration diagram of a dolly in an embodiment;

FIG. 3 is a block configuration diagram of a dolly management server of a dolly in an embodiment;

FIG. 4 is a configuration diagram of a dolly basic DB managed by the dolly management server;

FIG. 5 is a configuration diagram of a travel DB managed by the dolly management server;

FIG. 6A is a diagram illustrating an example of a dolly in a stopped state on a map;

FIG. 6B is a diagram illustrating an example of a map update;

FIG. 6C is a diagram illustrating another example of a map update;

FIG. 7 is a flowchart illustrating a processing procedure of a dolly in a first embodiment;

FIG. 8 is a flowchart illustrating a processing procedure of a dolly management server in the first embodiment;

FIG. 9 is a flowchart illustrating a processing procedure related to an alternative dolly and personnel dispatch in the first embodiment;

FIG. 10 is a flowchart illustrating a processing procedure of a dolly management server in a second embodiment;

FIG. 11A is a diagram for explaining a passage condition; and

FIG. 11B is a diagram for explaining a passage condition.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### First Embodiment

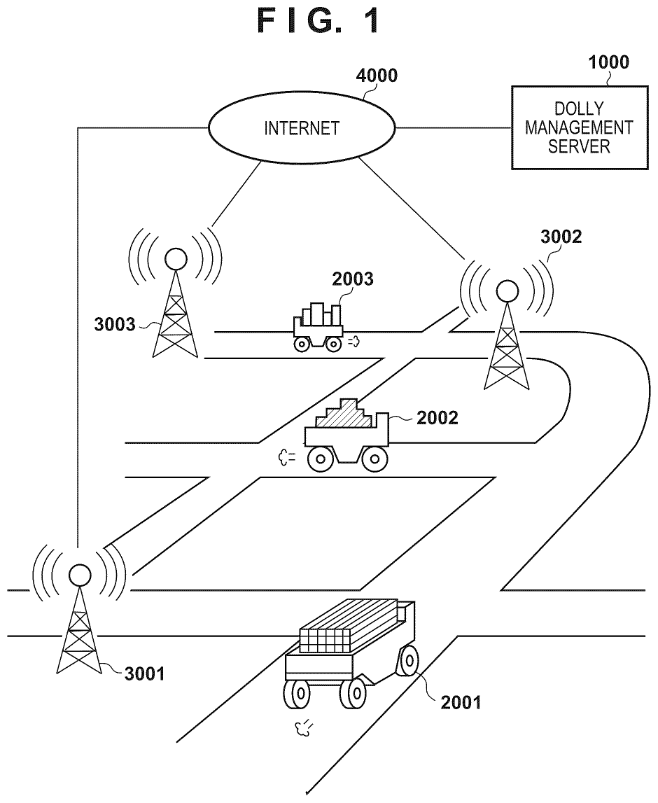

FIG. 1 is an overall configuration diagram of an operation control system of a mobile object in an embodiment.

The system includes dollies 2001 to 2003 that travel in a construction site and a dolly management server 1000 that manages the operation of each of the dollies 2001 to 2003. The dolly management server 1000 is connected to the Internet 4000. The type of connection form may be wired or wireless. In the construction site, base stations 3001 to 3003 are installed and connected to the internet 4000. Each of the dollies 2001 to 2003 can communicate with the base stations 3001 to 3003. Therefore, the dollies 2001 to 2003 and the dolly management server 1000 can communicate with each other via the base stations 3001 to 3003 and the internet 4000.

Note that, FIG. 1 illustrates an example in which the internet 4000 is interposed between the dollies 2001 to 2003 and the dolly management server 1000, but the type of communication means is not limited as long as the dollies 2001 to 2003 and the dolly management server 1000 can communicate with each other. It should be understood that FIG. 1 is merely an example. Although three dollies are illustrated in FIG. 1, the number of dollies is not particularly limited.

The dollies available in the system in the embodiment can include a dolly operated by a human and a dolly operated remotely, one of which is assumed to be an autonomously traveling type dolly. The autonomously traveling type dolly includes map data, a camera, and a position sensor, and has an ability to autonomously travel on a route to a set destination point using these. In order to simplify the description, the embodiment will be described assuming that all of the dollies 2001 to 2003 illustrated in FIG. 1 are autonomously traveling type dollies.

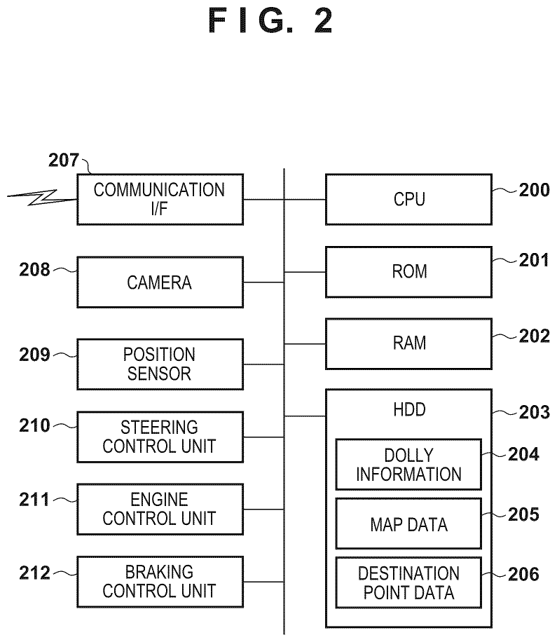

FIG. 2 is a block configuration diagram of the autonomously traveling type dolly 2001. It should be understood that the dollies 2002 and 2003 each have a similar configuration.

The dolly 2001 includes a CPU 200, a ROM 201, a RAM 202, an HDD 203, a communication I/F 207, a camera 208, a position sensor 209, a steering control unit 210, an engine control unit 211, and a braking control unit 212.

The HDD 203 stores dolly information 204, map data 205, and destination point data 206. The dolly information 204 contains an ID (hereinafter, a dolly ID) for identifying the dolly 2001 and size information (the width, length, and height) on the dolly 2001. The map data may be data on the range of a site in which the dolly 2001 travels. However, the map data contains information indicating the width of the travel route. The destination point data 206 is the coordinates of a destination point set by a user.

The communication I/F 207 is an interface for communicating with any of the base stations 3001 to 3003. In a case where some information is transmitted to the dolly management server 1000 via the communication I/F 207, the CPU 200 transmits information containing the dolly ID to the dolly management server 1000.

The camera 208 is set on a camera platform that can change the capturing direction, and captures an image of the front side of the dolly during normal travel. In addition, the camera 208 is a stereo camera, and can measure a shape of a subject and a distance to the subject.

The position sensor 209 detects at least the position (coordinates) of the dolly 2001 in the site. The position sensor 209 is typically a GPS sensor, but may be another sensor. The steering control unit 210, the engine control unit 211, and the braking control unit 212 operate under the control of the CPU 200 for the travel of the dolly 2001.

In the above configuration, the CPU 200 executes a program stored in the ROM 201, controls the steering control unit 210, the engine control unit 211, and the braking control unit 212 to control the travel of the dolly 2001. Specifically, the CPU 200 uses the coordinate position obtained by the position sensor 209 and the map data 205 while avoiding collision with an obstacle based on an image captured by the camera 208, and travels on the route in the site to the point indicated by the destination point data 206. Note that details of the processing of the CPU 200 of the dolly 2001 will be described later.

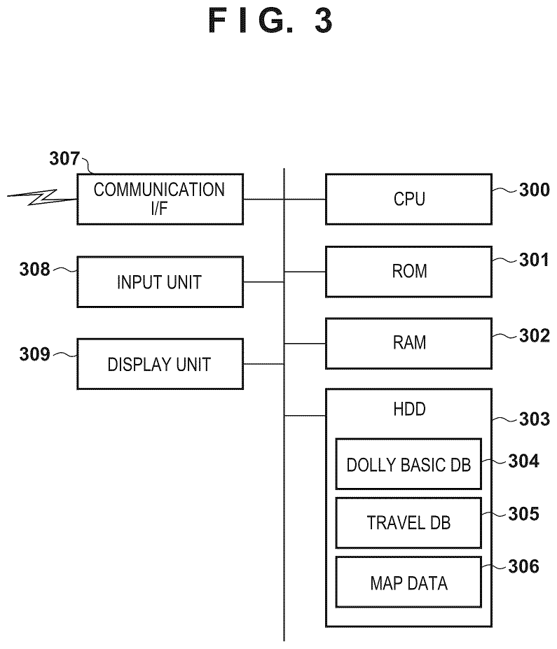

FIG. 3 is a diagram illustrating a block configuration diagram of the dolly management server 1000.

The dolly management server 1000 includes a CPU 300, a ROM 301, a RAM 302, an HDD 303, a communication I/F 307, an input unit 308, and a display unit 309.

The communication I/F 307 is an interface for connecting the dolly management server 1000 to the internet 4000. The dolly management server 1000 communicates with the dollies 2001 to 2003 via the communication I/F 307. The input unit 308 includes a pointing device, such as a keyboard and a mouse, and receives an operation of the user.

The HDD 303 stores a dolly basic database (DB) 304, a travel DB 305, and map data 306. Among them, the map data 306 is the same as the map data 205 included in the dollies 2001 to 2003.

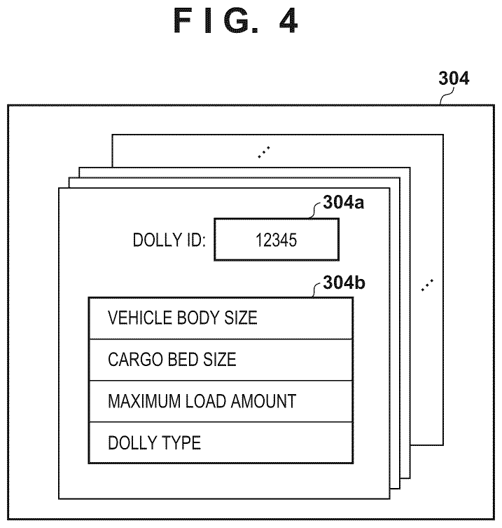

FIG. 4 illustrates a specific example of the dolly basic DB 304 held by the dolly management server 1000. The dolly basic DB 304 is constituted by dolly data indicating specifications of each dolly.

One piece of dolly data is constituted by a dolly ID 304a for uniquely specifying the dolly and dolly specification information 304b. In the illustrated case, “12345” is shown as the dolly ID 304a. The dolly specification information 304b contains a vehicle body size (the length, width, and height of the dolly), a cargo bed size (the length, width, and height of the cargo bed), a maximum load amount (in kg), and dolly type information (human driving type, remote control type, autonomous type) on the corresponding dolly. In a case where information has been received via the communication I/F 307, the dolly management server 1000 can identify the dolly of the transmission source of the information by searching the dolly basic DB 304 using the dolly ID contained in the information as a key.

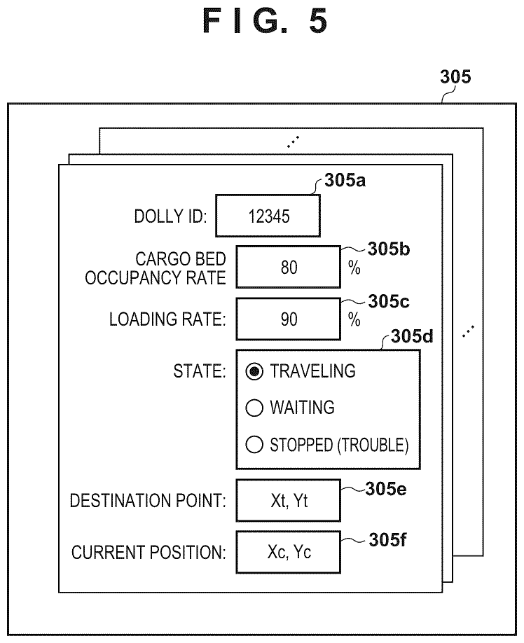

FIG. 5 illustrates a specific example of the travel DB 305 held by the dolly management server 1000. The travel DB 305 is data for managing the travel state of each dolly. The information on one dolly contains a dolly ID 305a, a cargo bed occupancy rate 305b, a loading rate 305c, a state 304d, a destination point 305e, and a current position 305f.

The cargo bed occupancy rate 305b indicates a percentage of the amount of material actually loaded to the cargo bed size (see FIG. 4) of the corresponding dolly. The percentage is 0% in a case where no material is loaded, and the percentage is 100% in a case where the material is fully loaded on the cargo bed. The loading rate 305c is a percentage of the weight of material actually loaded to the maximum load amount (see FIG. 4). The state 305d is any of traveling, standby, and stopped. “Traveling” indicates that the dolly is traveling to the destination point. “Standby” is a state of waiting for the next destination point to be set, such as a case where the dolly arrives at the destination point. This also includes a case where the dolly arrives at the destination point and the material is loaded and unloaded and the like. “Stopped” indicates a state in which the corresponding dolly has some trouble and cannot travel. Examples of the trouble include an engine trouble and a trouble in which the dolly is fitted into a cave-in on the route and cannot escape. The destination point 305e is the coordinates of the destination point in the site, and the current position 305f is the current (latest) coordinates of the dolly in the site.

The configurations of the dolly management server 1000 and the dollies 2001 to 2003 in the embodiment have been described above. Specific processing content of the CPU 300 of the dolly management server 1000 and the CPU 200 of the dolly 2001 is described.

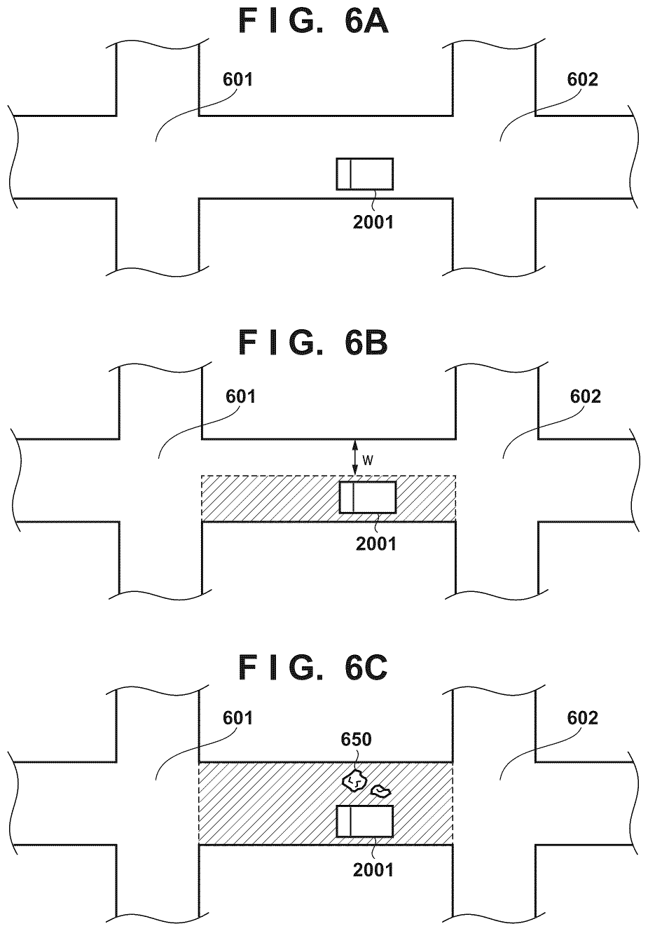

FIG. 6A illustrates an overhead view when the dolly 2001 is traveling on the route in the site. When performing travel control to the destination point, the CPU 200 of the dolly 2001 transmits a set of information, containing its own dolly ID and the current position, to the dolly management server 1000 at a preset cycle (for example, 10 seconds). The dolly management server 1000 receives this information and updates the current position 305f of the dolly 2001 in the travel DB 305 with the current position contained in the received information. The dolly management server 1000 updates the travel DB 305 according to information received from the other dollies 2002 and 2003. As a result, the dolly management server 1000 can grasp the current position (although there is a 10-second time difference) of each of the dollies 2001 to 2003 traveling in the site.

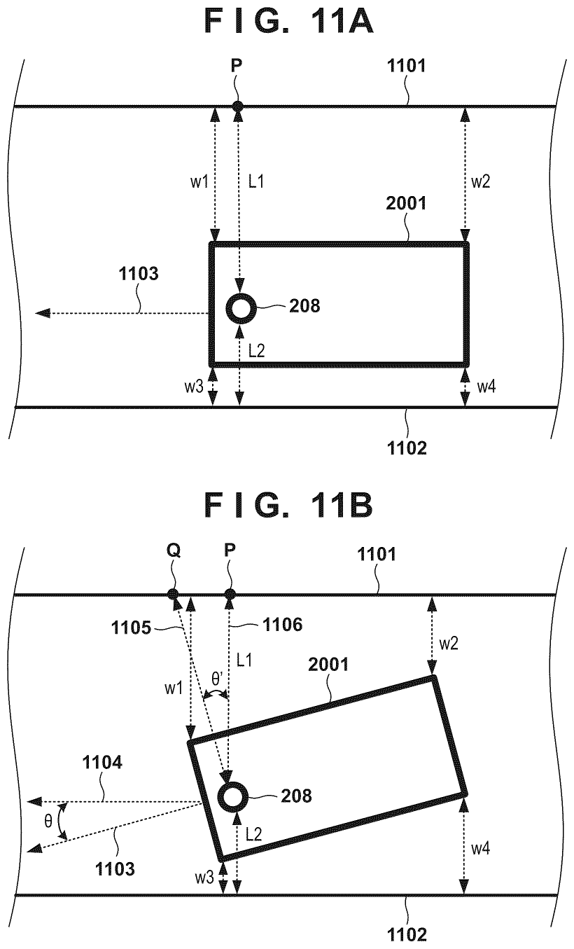

Now, it is assumed that the dolly 2001 is in a state of being unable to continue traveling because the dolly 2001 has fallen into a cave-in on the route or the like. In this case, the dolly 2001 can be an obstacle to the travel of the other dollies 2002 and 2003. Therefore, the CPU 200 of the dolly 2001 repeatedly changes the direction of the camera 208 to a preset direction and capture an image to acquire the image of the periphery of the dolly 2001. Then, based on the acquired images and its own vehicle body size in the dolly information 204, the CPU 200 determines a condition of a dolly that can pass by the dolly 2001, that is, the size that can pass by. This condition determination method is described with reference to FIGS. 11A and 11B.

In FIG. 11A, reference signs 1101 and 1102 respectively indicate left and right boundary lines of the route on which the dolly travels. When the dolly 2001 is stopped, the CPU 200 estimates, from the images captured by the camera 208, the position of the camera 208 of the dolly 2001 between the boundary lines 1101 and 1102 and the orientation of the dolly 2001 in a forward direction 1103. Then, the CPU 200 calculates four distances w1 to w4 between the front, rear, left, and right corners of the dolly 2001 and the boundary lines 1101 and 1192 based on the estimation. Then, the CPU 200 provisionally defines a larger space of the left and right spaces of the dolly 2001 as a space for another dolly to pass through, and determines the minimum distance in the space as an upper limit value of the vehicle width of the other dolly that can pass by the dolly 2001. This is described in more detail.

As described above, since the camera 208 in the embodiment is a stereo camera, the distance between each position in the captured images and the viewpoint (the camera 208) can be obtained by calculation. The CPU 200 obtains a position P on the boundary line 1101 on the right side in the traveling direction at which the distance to the camera 208 is minimum. The minimum distance is L1 illustrated in the drawing. Similarly, the CPU 200 obtains a minimum distance L2 between the left boundary line 1102 and the camera 208. As a result, the position of the camera 208 between the boundary lines 1101 and 1102 can be determined to be at L1:L2 of the width of the route.

In the illustrated case, the line segment indicated by the distance L1 is substantially perpendicular (90°) to the forward direction 1103. This means that the forward direction 1103 of the dolly 2001 is the same as the direction of the route to be traveled.

The installation position of the camera 208 with respect to the dolly 2001 is fixed (known). Consequently, the CPU 200 can estimate the positions of the front, rear, left, and right corners of the dolly 2001 from the above calculation result and the size information on the dolly 2001 indicated by the dolly information 204, and calculates the distances w1 to w4 between the respective corners and the boundary lines 1101 and 1102.

Of the left and right spaces in the traveling direction of the dolly 2001, the CPU 200 decides the space with the maximum distance (either w1 or w2 in the case of FIG. 11A) among the calculated distances w1 to w4 as a space for another dolly to pass by. Then, the CPU 200 decides a smaller distance (either w1 or w2) in the decided space for the other dolly to pass as a maximum vehicle width W of the other dolly that can pass by the dolly 2001.

While FIG. 11A shows an example where the forward direction 1103 of the dolly 2001 is the same as the direction of the route, FIG. 11B shows a different example.

In FIG. 11B, a reference sign 1104 indicates the direction of the route on which the dolly 2001 travels.

The minimum distance L1 between the boundary line 1101 and the camera 208 and the minimum distance L2 between the boundary line 1102 and the camera 208 in FIG. 11B can be obtained according to the method described with reference to FIG. 11A. That is, the distance at which the distance to the camera 208 on the boundary line 1101 is minimum is obtained as L1, and the distance at which the distance to the camera 208 on the boundary line 1102 is minimum is obtained as L2. As a result, the position of the camera 208 between the boundary lines 1101 and 1102 can be specified.

Therefore, the information necessary for obtaining the position and posture of the dolly 2001 is an angle θ formed by the forward direction 1103 of the dolly 2001 and the route direction 1104.

In a case where the forward direction 1103 and the route direction 1104 of the dolly 2001 are the same, that is, in the case of 0=0, the angle formed by the line segment connecting the point P and the camera 208 and the forward direction 1103 is 90°, as can be seen from FIG. 11A. However, as illustrated in FIG. 11B, the position on the boundary line 1101 at 90° with respect to the forward direction 1103 is a point Q, not the point P. As can be easily understood by those skilled in the art, when the angle formed by the line segment connecting the point P and the camera 208 and the line segment connecting the point Q and the camera 208 is 0′, the relationship is 0′=0. Consequently, the CPU 200 may calculate the viewing angle between the point P and the point Q in the image as θ′.

As a result, the position and posture of the dolly 2001 in the route can be estimated from the position of the camera 208 and the angle θ formed by the route direction 1104 and the forward direction 1103 of the dolly 2001. The position of the camera 208 with respect to the dolly 2001 and the size of the dolly 2001 are known. Consequently, the CPU 200 can calculate the front, rear, left, and right corner positions of the dolly 2001, and can also calculate the distances w1 to w4 between the respective corners and the boundary lines 1101 and 1102.

Therefore, in the case of the example in FIG. 11B, the CPU 200 decides the right side space of the dolly 2001 with the maximum distance w1 among the four distances w1 to w4 as the space for another dolly to pass. Then, the CPU 200 decides a smaller distance w2 in the decided space for the other dolly to pass as the maximum vehicle width W of the other dolly that passes by the dolly 2001.

Note that, in the above description, W is decided as the maximum vehicle width of the other dolly that passes by the dolly 2001, but the value includes a certain degree of error. It is assumed that the type of dolly that can travel in the site is determined in advance, and that the vehicle width is any one of Wv1, Wv2, Wv3, . . . and so on. In this case, the vehicle width Wvi (i=any of 1, 2, . . . ) closest to W, which is equal to or less than the calculated W, may be decided as the final maximum vehicle width of the other dolly that passes by the dolly 2001.

The description returns to FIG. 6A. As described above, when having decided the condition (maximum vehicle width W) related to the size of the dolly that passes by the dolly 2001, the CPU 200 searches the map data 205 to acquire the positions of closest two branch points 601 and 602 sandwiching the current position of the dolly 2001. Then, as illustrated in FIG. 6B, the CPU 200 shares the fact that the road width of the route sandwiched by the branch points 601 and 602 is W with the other dollies 2002 and 2003. Therefore, the CPU 200 generates a map update request message (containing the dolly ID and the current position information) indicating that the road width of the route sandwiched by the branch points 601 and 602 is W, and transmits the map update request message to the dolly management server 1000.

When receiving the map update request message from the dolly 2001, the CPU 300 of the dolly management server 1000 updates the map data 306 and transmits the received map update request message to the other dollies 2002 and 2003. As a result, the fact that the road width of the route sandwiched by the branch points 601 and 602 is W can be shared by all of the dollies.

When receiving the map update request message, the CPU of the dolly 2002 updates the map data held by itself (the same applies to the dolly 2003). Then, the CPU of the dolly 2002 reads the vehicle width indicated by the dolly information held by itself, and performs a re-search for the route from the current position to the destination point with reference to the updated map data under the condition of “vehicle width <road width”. Then, the CPU of the dolly 2002 resumes the traveling control according to the result of the re-search. Whether the route to the destination point is the same before and after the map update request message is received depends on the size, current position, and destination point of the dolly 2002.

In addition to its own size information, the HDD 203 of the dolly 2001 stores information indicating the minimum size of the dolly traveling in the site. This allows for the following.

First, in a case where the maximum vehicle width W obtained in the processing described above is smaller than the vehicle width of the minimum size dolly, the CPU 200 of the dolly 2001 does not allow all of the dollies in the site to pass by the dolly 2001. In addition, in a case where an obstacle, such as a rock of a preset size or larger or a cave-in, is detected in the space for the other dolly to pass from the captured images, the CPU 200 updates the calculated W to be smaller in order to avoid the obstacle. Even in such a case, the updated maximum vehicle width W can be smaller than the vehicle width of the minimum size. As described above, in a case where the decided vehicle width W is smaller than the vehicle width of the minimum size dolly, the CPU 200 generates a map update request message for making the route between the branch points 601 and 602 inaccessible as illustrated in FIG. 6C, and transmits the map update request message to the dolly management server 1000. The illustrated reference sign 650 represents the obstacle (for example, a rock) described above. The dolly 2002 that has received the map update request message updates the route between the branch points 601 and 602 in the map data so as to be inaccessible, and then, performs the route search (the same applies to the dolly 2003).

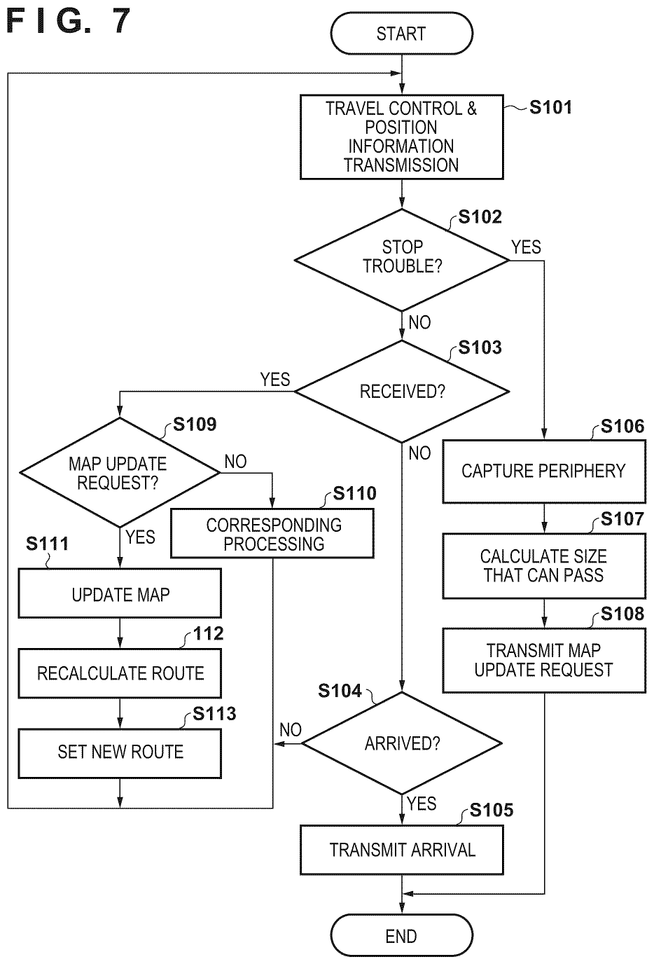

In order to achieve the above, specific processing of the CPU 200 of the dolly 2001 is described below with reference to the flowchart in FIG. 7. It should be understood that the CPUs of the dollies 2002 and 2003 also perform the same processing.

In S101, the CPU 200 controls the steering control unit 210, the engine control unit 211, and the braking control unit 212 with reference to the images of the front side by the camera 208 and the map data 205 to perform travel control to the destination point of the dolly 2001. Note that, during the travel control, the CPU 200 transmits a message indicating normal travel, in which the position information obtained by the position sensor 209 and its own dolly ID are paired, to the dolly management server 1000 at preset time intervals (for example, intervals of 10 seconds).

In S102, the CPU 200 determines whether a stop trouble has occurred. In a case where it is determined that there is no stop trouble, the CPU 200 advances the processing to S103, and determines whether any information has been received from the dolly management server 1000. In a case where it is determined that no information has been received from the dolly management server 1000, the CPU 200 advances the processing to S104, and determines whether the dolly 2001 has arrived at the destination point by comparing the difference between the current position and the position indicated by the destination point data 206 with a threshold. In a case where the result of the determination is negative, the CPU 200 returns the processing to S101 and continues the travel control. Then, during the travel control, in a case where it is determined that the dolly 2001 has arrived at the destination point, the CPU 200 advances the processing from S104 to S105, transmits a destination point arrival message containing the dolly ID to the dolly management server 1000, and terminates the travel control processing. In a case of the work of unloading loaded materials, or arriving at the material yard with an empty cargo bed, the work of loading materials is performed.

In a case where there is no trouble and there is no reception of information from the dolly management server 1000, the CPU 200 continues the travel control processing to the destination point and the transmission processing of the message indicating normal travel as described above.

Here, it is assumed that the dolly 2001 has a trouble for some reason and is unable to travel before reaching the destination point. In this case, the CPU 200 branches the processing from S102 to S106. In S106, in order to recognize the situation of the periphery of the dolly, the CPU 200 controls the camera 208 to capture a plurality of images of the periphery of the dolly 2001. Then, in S107, the CPU 200 calculates the condition (the vehicle width W described above) of a dolly that can pass from the plurality of captured images and the size information in the dolly information 204. Then, in S108, in order to share this condition with the other dollies, the CPU 200 generates a map update request message containing the dolly ID, the current position, the calculated condition, and the branch points 601 and 602, transmits the map update request message to the dolly management server 1000, and terminates this processing.

As a result of the above processing, in a case where the dolly 2001 is in an unintended stopped state while traveling to the destination point, the map update message is transmitted to the other dollies 2002 and 2003, and the updated map data can be shared. Therefore, the dolly 2002 can re-search for the travel route at the timing of receiving this message, regardless of the positional relationship with the dolly 2001, and resume traveling on the shortest travel route to the destination point (the same applies to the dolly 2003). For example, it is assumed that the dolly 2002 exceeds the vehicle width W decided by the dolly 2001 and is scheduled to travel on the same route as the dolly 2001. In this case, in a case where the timing at which the dolly 2002 receives the message is before reaching the branch point 602, it is possible to travel avoiding the route between the branch points 601 and 602. That is, it is possible to avoid a situation in which the dolly 2002 arrives near the dolly 2001 and turns back.

Next, a case where the dolly 2001 receives the map update request message from the dolly management server 1000 is described. This situation is easily understood, for example, by considering the case where the dolly 2002 has a stop trouble while traveling to the destination.

In this case, the CPU 200 determines that information has been received from the dolly management server 1000 in S103. Therefore, the CPU 200 advances the processing and determines whether the received information is the map update request message. In a case where the message is other than the map update request message, the CPU 200 advances the processing to S110, performs processing according to the corresponding request, and then returns the processing to S101.

On the other hand, in a case where it is determined that the received information is the map update request message in S109, the CPU 200 advances the processing to S111. In S111, the CPU 200 updates the map data 205 by correcting the passable width of the corresponding route or setting the route as inaccessible based on the information contained in the received map update request message. Then, in S112, the CPU 200 performs a route search to the destination point indicated by the destination point data 206 with the current position obtained by the position sensor 209 as the departure point with reference to the updated map data 205. Then, in S113, the CPU 200 sets the route obtained by the route search, and returns the processing to S101. As a result, the dolly 2001 travels to the destination point according to the route set in S113. As described above, whether the route set in S113 is the same as that before the map update request message is received depends on the position and width indicated by the updated route on the map indicated by the map update request message, and the position, size, and destination point of the dolly 2001.

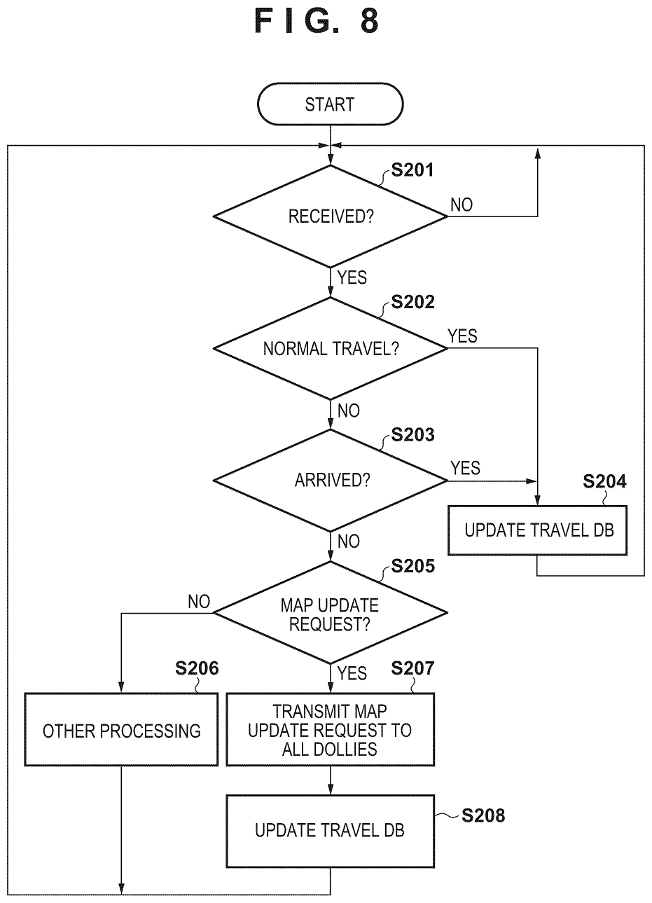

Next, specific processing of the CPU 300 of the dolly management server 1000 in the embodiment is described below with reference to the flowchart in FIG. 8.

In S201, the CPU 300 waits to receive information from one of the dollies. When receiving information, the CPU 300 determines the type of the received information in S202, S203, and S205.

In a case where the received information is a normal travel message, the CPU 300 advances the processing from S202 to S203, and updates the current position 305f (see FIG. 5) of the corresponding dolly ID in the travel DB 305 based on the dolly ID and the position information contained in the received normal travel message.

In a case where the received information is a destination point arrival message, the CPU 300 advances the processing from S203 to S204, updates the current position 305f (see FIG. 5) of the corresponding dolly ID in the travel DB 305 based on the dolly ID and the position information contained in the received destination point arrival message, and changes the state 305d (see FIG. 5) to “standby”.

In a case where the received information is a map update request message, the CPU 300 advances the processing from S205 to S207, updates the map data 306 according to the received map update request message, and transmits the map update request message to all of the dollies. Then, in S208, the CPU 300 updates the current position 305f of the corresponding dolly ID in the travel DB 305 based on the dolly ID and the position contained in the received map update request message, and changes the state 305d (see FIG. 5) to “stopped”.

Note that, in S207, all of the dollies are targeted for transmission of the map update request message, but the dolly of the transmission source of the map update request message may be excluded from the transmission target. In addition, a dolly with a vehicle width less than the width W of the route contained in the received map update request message does not need to perform a route search, and thus may be excluded from the transmission target in the processing in S207.

In addition, in a case where it is determined that the received information is a message other than the above, the CPU 300 advances the processing from S205 to S206 and performs the corresponding processing.

According to the above embodiment, when a certain dolly has a stop trouble, the other dollies can update their own map data by regarding the dolly as an obstacle, and can perform a route search again. As a result, the other dollies can travel on the optimal route without useless travel.

Note that, leaving a dolly in the stopped state increases the possibility that other dollies detour around the route including the position. Therefore, processing of dispatching a rescue team to the stopped dolly is described. The CPU 300 of the dolly management server 100 monitors the travel DB 305 in a separate task, and in a case where a state becomes “stopped”, displays a warning message on the display unit 305 indicating that there is a stopped dolly. In a case where a user (administrator) sees this, searches the travel DB and finds the stopped dolly, the execution is assumed to be started by an instruction of the administrator. Therefore, it is assumed that the user (administrator) searches for a dolly with the state 305d in the travel DB 305 is “stopped” and acquires the dolly ID.

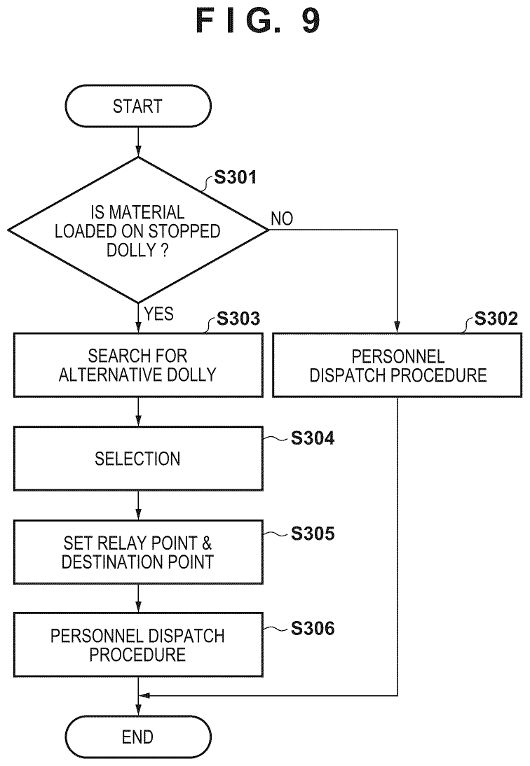

Hereinafter, rescue team dispatch processing is described with reference to FIG. 9.

In S301, the CPU 300 determines whether the corresponding stopped dolly is loaded with a material based on the cargo bed occupancy rate 305b or the loading rate 305c in the travel DB 305. In a case where the cargo bed occupancy rate 305b (or the loading rate 305c) is zero, it indicates that no material is loaded, and in a case where the cargo bed occupancy rate is other than zero, it indicates that a material is loaded.

In a case where it is determined that the stopped dolly is not loaded with a material, the CPU 300 advances the processing to S302, and performs a rescue team dispatch procedure to the position indicated by the current position 305f of the dolly ID. In this case, since no material is loaded on the stopped dolly, it is not necessary to prepare an alternative dolly.

On the other hand, in a case where it is determined that the stopped dolly is loaded with a material, the CPU 300 advances the processing to S303. In S303, the CPU 300 searches the dolly basic DB 304 using the stopped dolly ID as a key, and acquires the cargo bed size and the maximum load amount. Then, the CPU 300 multiplies the cargo bed size by the cargo bed occupancy rate to obtain the size of the space for loading the material, and multiplies the maximum load amount by the loading rate to obtain the necessary load amount. An alternative dolly candidate on which the corresponding material can be loaded is searched for from the travel DB 305. Then, in S304, the CPU 300 displays the list of the alternative dollies obtained by the search in order of proximity to the stopped dolly, and allows the user to select an alternative dolly.

Thereafter, in S305, the CPU 300 sets the current position of the stopped dolly as a relay point of the selected alternative dolly, and adds the destination point of the stopped dolly to the destination point of the alternative dolly. Then, the CPU 300 transmits a request message to the alternative dolly to start traveling to the relay point.

Then, in S306, the CPU 300 performs a procedure of dispatching personnel for transferring the material from the stopped dolly to the alternative dolly and a rescue team. Note that the alternative dolly may estimate the arrival time at the set relay point and notify the rescue team of the time.

As a result, the rescue team can be dispatched to the dolly having the stop trouble. In addition, since it is known from the travel DB whether the stopped dolly is loaded with a material, it is also possible to dispatch a dolly that carries the material as a substitute, in consideration of the amount of material loaded on the stopped dolly.

Note that, in the above embodiment, it has been described that the map update request message created by the dolly 2001 contains the positions of the branch points 601 and 602 closest to the dolly 2001. However, since the dolly management server and the other dollies 2002 and 2003 can acquire the positions of the branch points 601 and 602 from the position of the dolly 2001 with reference to the map data, the positions of the branch points 601 and 602 may not be contained in the map update request message.

In addition, in the above embodiment, it has been described that the imaging direction of the camera 208 included in the dolly can be changed, but a plurality of cameras having mutually different viewing directions may be mounted, for example. In addition, it has been described that an image by the camera is used to obtain the size of a dolly that can pass by the dolly in the stopped state, but the space size of the periphery of the dolly in the stopped state may be measured using a distance sensor or the like.

Furthermore, in the above embodiment, it has been described that each dolly and the dolly management server that have received a map update request update their own map data, but the original map data may be left as it is, and the width of the route at the coordinate position indicated by the update request may be independently stored as correction data of the map data. In a case where the dolly in the stopped state moves, only the correction data needs to be deleted, and complicated processing of updating the map data is unnecessary.

In addition, in the above embodiment, it has been described that the dolly management server transmits the map update request message received from the dolly in the stopped state to the other dollies. However, each dolly may directly communicate with the other dollies. In this case, each dolly needs to hold information such as network addresses of the other dollies. Therefore, it is desirable to interpose the dolly management server as in the above-described embodiment. In addition, the intervention of the dolly management server also has an advantage that operations such as where the stopped dolly is located and whether to dispatch a rescue team can be performed by a single device.

In the above embodiment, it has been described that a rescue team is dispatched to the dolly in the stopped state. However, in a case where the dolly in the stopped state can be switched from the autonomous type to the remote operation type, the dolly may be switched to the remote operation, and returned from the stopped state by the remote operation. In a case where the dolly 2001 is operated in the remote operation mode, an image captured by the camera 208 is transmitted to a remote operation terminal operated by the user (which may be the dolly management server), and the CPU 200 may control the steering control unit 210, the engine control unit 221, and the braking control unit 212 according to an instruction from the terminal.

### Second Embodiment

In the first embodiment, an example in which a dolly that autonomously travels itself detects a stop trouble and also transmits a map update request message has been described. However, an example in which the processing is performed by the dolly management server 1000 is described as a second embodiment.

A system configuration in the second embodiment is the same as that in the first embodiment as illustrated in FIG. 1. Also in the second embodiment, dollies 2001 to 2003 are capable of autonomously traveling, but the processing content thereof is simple as compared with the first embodiment. Each of the dollies 2001 to 2003 does not perform the processing in S102 and S106 to S108 in the flowchart in FIG. 7. That is, the processing in S103 is performed immediately after S101. Therefore, descriptions other than the processing specific to the dollies 2001 to 2003 in the present second embodiment are omitted.

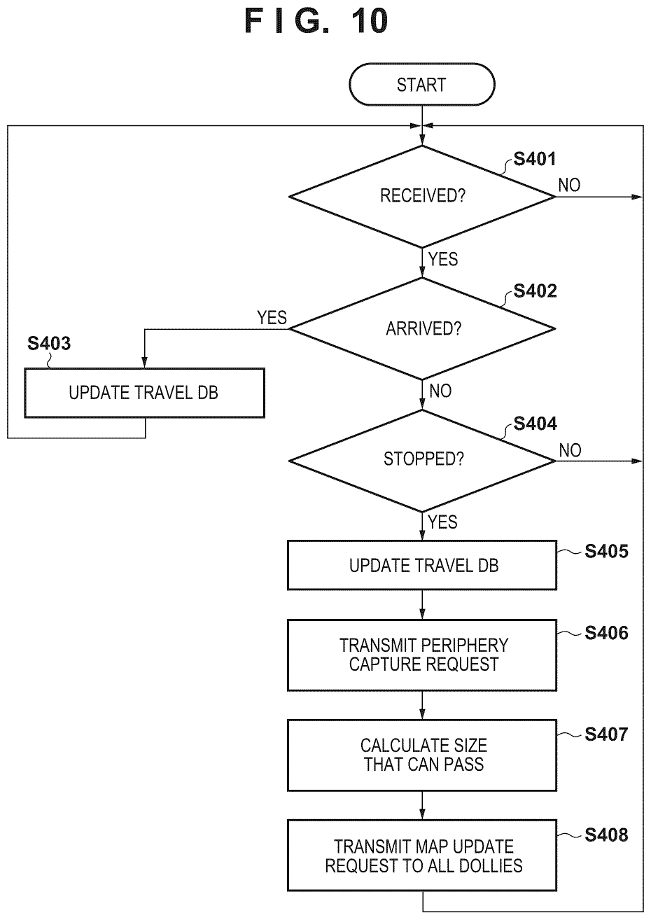

FIG. 10 is a flowchart illustrating processing performed by a CPU 300 of a dolly management server 1000 in the second embodiment. Hereinafter, a description will be given with reference to the drawing.

First, in S401, the CPU 300 of the dolly management server 1000 waits to receive information from one of the dollies. Then, in a case where it is determined that information has been received, the CPU 300 advances the processing to S402, and determines whether the received information is a message indicating destination arrival. In a case where it is determined that the message is the destination arrival message, the CPU 300 advances the processing to S403, and updates a travel DB 305 based on the dolly ID and the current position contained in the received information. Specifically, the CPU 300 sets the received state 305d of the dolly ID to “standby” and updates the current position 305f. In a case where it is determined that the received information is other than the destination arrival message (in the case of the message indicating normal travel in the first embodiment), the CPU 300 advances the processing to S404. In S404, the CPU 300 determines whether the dolly indicated by the dolly ID is in the stopped state based on the dolly ID and the current position contained in the received information.

In the embodiment, it is assumed that each dolly transmits information in which the dolly ID and the current position are paired to the dolly management server 1000 at predetermined time intervals (for example, at intervals of 10 seconds). Therefore, when the current position contained in the information received this time is the same as the position indicated by the current position 305f of the corresponding dolly in the travel DB 305, it can be determined that the dolly has not moved for the predetermined time (10 seconds). Therefore, in the second embodiment, in a case where the determination that the previous and current coordinate positions are the same continues for a preset number of times (for example, six times) or a preset time (for example, one minute), it is estimated that the corresponding dolly has some trouble and is in the stopped state.

In S404, in a case where it is determined that the current position of the dolly with the dolly ID contained in the received information is different from the position indicated by the current position 305f of the corresponding dolly in the travel DB 305, the CPU 300 determines that the corresponding dolly is traveling. In this case, the CPU 300 updates the corresponding current position 305f in the travel DB 305 with the received position based on the dolly ID contained in the received information, and returns the processing to S401.

On the other hand, in a case where it is determined in S404 that the dolly with the dolly ID contained in the received information is in the stopped state, the CPU 300 advances the processing to S405.

In S405, the CPU 300 sets the state 305d in the travel DB indicated by the dolly ID contained in the received information to “stopped”. Then, in S406, the CPU 300 transmits a request message for acquiring an image of the periphery of the dolly indicated by the received dolly ID. When receiving this request message, (the CPU of) the dolly repeats capturing images while shifting the viewing direction of the camera 208 by a preset angle. Then, the corresponding dolly transmits the captured images to the dolly management server 1000. The processing of the dolly is performed in S110 in FIG. 7. After transmitting the request message for acquiring an image, the CPU 300 of the dolly management server 1000 receives the captured images from the corresponding dolly.

When receiving the images, in S407, the CPU 300 refers to the received images, the current position indicated by the dolly ID, the size information indicated by the dolly ID, and the map data 306 to calculate the vehicle width W for passing by the corresponding dolly. The principle of the calculation of the vehicle width W is the same as that in the first embodiment. Thereafter, in S408, the CPU 300 generates a map update request message and transmits the map update request message to all of the dollies.

As described above, according to the second embodiment, each dolly may simply travel to a set destination point and perform camera control according to the dolly management server, and the dolly management server 1000 can detect a stop trouble and handle the stop trouble.

According to the present invention, when a certain mobile object is in a stopped state, a condition related to the size of a mobile object that can pass by the certain mobile object is decided, and the condition is shared with other dollies. As a result, the other dollies can decide whether to detour or pass the route on which the mobile object in the stopped state is located at an early stage without useless traveling.

### Summary of Embodiments

The above embodiments disclose at least the following operation control system of a mobile object.
1. An operation control system of a mobile object configured to be autonomously movable according to the above embodiment is an operation control system comprising:
a position detection unit configured to detect a position of the mobile object;
a recognition unit configured to recognize a state of a periphery of the mobile object;
a decision unit configured to decide, in a case where the mobile object is in a stopped state, a condition for another mobile object to pass by the mobile object according to a result of the recognition by the recognition unit; and
a sharing unit configured to share information indicating the position of the mobile object in the stopped state detected by the position detection unit and the condition decided by the decision unit with the other mobile object.

According to this embodiment, in response to the stop of a mobile object, a condition for another mobile object to pass by the mobile object in the stopped state is decided, and the condition is shared with the other mobile object. As a result, it is possible for the other mobile object to decide whether to detour or pass the route on which the mobile object in the stopped state is located at an early stage without useless traveling.
2. In the operation control system of the mobile object according to the above embodiment, wherein
the recognition unit includes a camera configured to capture an image of the periphery of the mobile object, and
the decision unit decides, based on the image captured by the camera and size information on the mobile object, a size of the other mobile object to pass by the mobile object in the stopped state as the condition.

According to this embodiment, it is possible for the other mobile object to easily determine whether it is necessary to detour to the destination by comparing its own size with the shared size.
3. In the operation control system of the mobile object according to the above embodiment, the operation control system further comprising:
a server configured to manage operations of a plurality of mobile objects, wherein
each of the mobile objects includes the position detection unit, the recognition unit, the decision unit, and the sharing unit,
the sharing unit includes a unit configured to transmit information indicating the condition decided by the decision unit to the server, and
the server includes a unit configured to transmit, in a case where the information indicating the condition is received from the mobile object, the received information to other mobile objects.

According to this embodiment, it is possible for the mobile object in the stopped state to share the condition with the other mobile objects only by notifying the server of information indicating the condition.
4. In the operation control system of the mobile object according to the above embodiment, the operation control system further comprising:
a server configured to manage operations of a plurality of mobile objects, wherein
   the mobile object includes the position detection unit, a camera configured to capture an image of the periphery of the mobile object, and a unit configured to transmit information indicating the position obtained by the position detection unit to the server at a preset time interval,
   the server includes: the recognition unit; the decision unit; and the sharing unit, the server further includes: a determination unit configured to determine whether the mobile object is in the stopped state based on whether the information indicating the position contained in the information received from the mobile object has changed,
the recognition unit requests the mobile object decided by the decision unit to be in the stopped state to capture an image of the periphery of the mobile object by the camera, and receives the image captured by the camera to recognize the state of the periphery of the mobile object,
the decision unit decides, based on a result of the recognition by the recognition unit and size information on the mobile object in the stopped state, a size of another mobile object to pass by the mobile object as the condition, and
the sharing unit transmits information indicating the condition decided by the decision unit to each of the mobile objects.

According to this embodiment, it is possible to share information indicating the condition for passing by the mobile object in the stopped state with the other mobile objects after simplifying the configuration of the mobile objects.
5. In the operation control system of the mobile object according to the above embodiment, wherein
each of the mobile objects includes a travel control unit configured to refer to information indicating a size of its own mobile object and map data to travel to a destination, an update unit configured to update, when the information indicating the condition is received from the server, the map data based on the condition, and a route search unit configured to re-search for a route to the destination by using the updated map data and the size, and
the travel control unit performs travel control according to the route obtained by re-searching by the route search unit.

According to this embodiment, since the other traveling dollies update the map data at the timing of receiving the information indicating the condition and re-searches for a route, it is possible to perform the route search in a short time from the timing when the mobile object is in the stopped state.
6. In the operation control system of the mobile object according to the above embodiment, wherein each mobile object is a dolly having a cargo bed for loading a material.

According to this embodiment, it is possible to manage the operation of the dolly loaded with a material.
7. In the operation control system of the mobile object according to the above embodiment, wherein the operation control system further comprising: a server configured to manage operations of a plurality of mobile objects, and wherein
the server includes a holding unit configured to hold information indicating a position of each mobile object and an amount of loaded material, and a dispatch unit configured to search, in a case where the mobile object in the stopped state is loaded with a material, for an alternative dolly to which the material is to be transferred, and to dispatch the alternative dolly obtained by the search to the position of the mobile object in the stopped state.

According to this embodiment, even when the dolly loaded with a material is in the stopped state, an alternative dolly for carrying the material is dispatched to the position of the mobile object in the stopped state, and it is possible to smoothly procure the material, and to minimize the delay of the construction plan.
8. A control method of an operation control system of a mobile object configured to be autonomously movable according to the above embodiment is a control method comprising:
detecting a position of the mobile object;
recognizing a state of a periphery of the mobile object;
deciding, in a case where the mobile object is in a stopped state, a condition for another mobile object to pass by the mobile object according to a result of the recognition in the recognizing the state; and
sharing information indicating the position of the mobile object in the stopped state detected in the detecting the position and the condition decided in the deciding the condition with the other mobile object.

According to this embodiment, in response to the stop of a mobile object, a condition for another mobile object to pass by the mobile object in the stopped state is decided, and the condition is shared with the other mobile object. As a result, it is possible for the other mobile object to decide whether to detour or pass the route on which the mobile object in the stopped state is located at an early stage without useless traveling.
9. A storage medium storing a program causing, when read and executed by a computer, the computer to execute the method according to the above embodiment is provided.

According to this embodiment, it is possible to achieve a storage medium storing a program having the same functions and effects as those of the above method.
10. A management device configured to manage operations of a plurality of mobile objects configured to be autonomously movable according to the above embodiment is a management device comprising:
a management unit configured to receive information indicating a current position from each of the mobile objects via a communication unit to manage a state related to movement of each of the mobile objects;
a recognition unit configured to recognize, in a case where there is a mobile object in a stopped state among the mobile objects managed by the management unit, a state of a periphery of the mobile object in the stopped state;
a decision unit configured to decide a condition for another mobile object to pass by the mobile object in the stopped state according to a result of the recognition by the recognition unit; and
a sharing unit configured to share information indicating the position of the mobile object in the stopped state and the condition decided by the decision unit with the mobile objects managed by the management unit.

According to the present embodiment, it is possible for the management device to manage the state related to the movement of each of the mobile objects, to decide, in response to any of the mobile objects to be managed having stopped for some reason, the condition for another mobile object to pass by the mobile object in the stopped state, and to share the position of the mobile object in the stopped state and the condition with the other mobile objects. As a result, it is possible for the other traveling mobile objects to determine whether to detour or pass the route on which the mobile object in the stopped state is located at an early stage without useless traveling, and to select a detour as necessary.
11. A control method of a management device configured to manage operations of a plurality of mobile objects configured to be autonomously movable according to the above embodiment is a control method comprising:
managing a state related to movement of each of the mobile objects by receiving information indicating a current position from each of the mobile objects via a communication unit;
recognizing, in a case where there is a mobile object in a stopped state among the mobile objects managed in the managing the state, a state of a periphery of the mobile object in the stopped state;
deciding a condition for another mobile object to pass by the mobile object in the stopped state according to a result of the recognition in the recognizing the state; and
sharing information indicating the position of the mobile object in the stopped state and the condition decided in the deciding the condition with the mobile objects managed in the managing the state.

According to the present embodiment, it is possible, by performing the control method, to manage the state related to the movement of each of the mobile objects, to decide, in response to any of the mobile objects to be managed having stopped for some reason, the condition for another mobile object to pass by the mobile object in the stopped state, and to share the position of the mobile object in the stopped state and the condition with the other mobile objects. As a result, it is possible for the other traveling mobile objects to determine whether to detour or pass the route on which the mobile object in the stopped state is located at an early stage without useless traveling, and to select a detour as necessary.
12. A storage medium storing a program causing, when read and executed by a computer, the computer to execute the method according to the above embodiment is provided.

According to this embodiment, it is possible to achieve a storage medium storing a program having the same functions and effects as those of the above method.

The invention is not limited to the foregoing embodiments, and various variations/changes are possible within the spirit of the invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An operation control system of a mobile object configured to be autonomously movable, the operation control system comprising:
a position detection unit configured to detect a position of the mobile object;
a recognition unit configured to recognize a state of a periphery of the mobile object;
a decision unit configured to decide, in a case where the mobile object is in a stopped state, a condition for another mobile object to pass by the mobile object according to a result of the recognition by the recognition unit; and
a sharing unit configured to share information indicating the position of the mobile object in the stopped state detected by the position detection unit and the condition decided by the decision unit with the other mobile object.

2. The operation control system of the mobile object according to claim 1, wherein
the recognition unit includes a camera configured to capture an image of the periphery of the mobile object, and
the decision unit decides, based on the image captured by the camera and size information on the mobile object, a size of the other mobile object to pass by the mobile object in the stopped state as the condition.

3. The operation control system of the mobile object according to claim 1, the operation control system further comprising:
a server configured to manage operations of a plurality of mobile objects, wherein
each of the mobile objects includes the position detection unit, the recognition unit, the decision unit, and the sharing unit,
the sharing unit includes a unit configured to transmit information indicating the condition decided by the decision unit to the server, and
the server includes a unit configured to transmit, in a case where the information indicating the condition is received from the mobile object, the received information to other mobile objects.

4. The operation control system of the mobile object according to claim 1, the operation control system further comprising:
a server configured to manage operations of a plurality of mobile objects, wherein
the mobile object includes
the position detection unit,
a camera configured to capture an image of the periphery of the mobile object, and
a unit configured to transmit information indicating the position obtained by the position detection unit to the server at a preset time interval,
the server includes:
the recognition unit;
the decision unit; and
the sharing unit,
the server further includes:
a determination unit configured to determine whether the mobile object is in the stopped state based on whether the information indicating the position contained in the information received from the mobile object has changed,
the recognition unit requests the mobile object decided by the decision unit to be in the stopped state to capture an image of the periphery of the mobile object by the camera, and receives the image captured by the camera to recognize the state of the periphery of the mobile object,
the decision unit decides, based on a result of the recognition by the recognition unit and size information on the mobile object in the stopped state, a size of another mobile object to pass by the mobile object as the condition, and
the sharing unit transmits information indicating the condition decided by the decision unit to each of the mobile objects.

5. The operation control system of the mobile object according to claim 3, wherein
each of the mobile objects includes
a travel control unit configured to refer to information indicating a size of its own mobile object and map data to travel to a destination,
an update unit configured to update, when the information indicating the condition is received from the server, the map data based on the condition, and
a route search unit configured to re-search for a route to the destination by using the updated map data and the size, and
the travel control unit performs travel control according to the route obtained by re-searching by the route search unit.

6. The operation control system of the mobile object according to claim 1, wherein each mobile object is a dolly having a cargo bed for loading a material.

7. The operation control system of the mobile object according to claim 6, wherein the operation control system further comprising:
a server configured to manage operations of a plurality of mobile objects, and wherein
the server includes
a holding unit configured to hold information indicating a position of each mobile object and an amount of loaded material, and
a dispatch unit configured to search, in a case where the mobile object in the stopped state is loaded with a material, for an alternative dolly to which the material is to be transferred, and to dispatch the alternative dolly obtained by the search to the position of the mobile object in the stopped state.

8. A control method of an operation control system of a mobile object configured to be autonomously movable, the control method comprising:
detecting a position of the mobile object;
recognizing a state of a periphery of the mobile object;
deciding, in a case where the mobile object is in a stopped state, a condition for another mobile object to pass by the mobile object according to a result of the recognition in the recognizing the state; and
sharing information indicating the position of the mobile object in the stopped state detected in the detecting the position and the condition decided in the deciding the condition with the other mobile object.

9. A storage medium storing a program causing, when read and executed by a computer, the computer to execute the method according to claim 8.

10. A management device configured to manage operations of a plurality of mobile objects configured to be autonomously movable, the management device comprising:
a management unit configured to receive information indicating a current position from each of the mobile objects via a communication unit to manage a state related to movement of each of the mobile objects;
a recognition unit configured to recognize, in a case where there is a mobile object in a stopped state among the mobile objects managed by the management unit, a state of a periphery of the mobile object in the stopped state;
a decision unit configured to decide a condition for another mobile object to pass by the mobile object in the stopped state according to a result of the recognition by the recognition unit; and
a sharing unit configured to share information indicating the position of the mobile object in the stopped state and the condition decided by the decision unit with the mobile objects managed by the management unit.

11. A control method of a management device configured to manage operations of a plurality of mobile objects configured to be autonomously movable, the control method comprising:
managing a state related to movement of each of the mobile objects by receiving information indicating a current position from each of the mobile objects via a communication unit;
recognizing, in a case where there is a mobile object in a stopped state among the mobile objects managed in the managing the state, a state of a periphery of the mobile object in the stopped state;
deciding a condition for another mobile object to pass by the mobile object in the stopped state according to a result of the recognition in the recognizing the state; and
sharing information indicating the position of the mobile object in the stopped state and the condition decided in the deciding the condition with the mobile objects managed in the managing the state.

12. A storage medium storing a program causing, when read and executed by a computer, the computer to execute the method according to claim 11.
